(19) United States
(12) Patent Application Publication
(10) Pub. No.: US 2007/0164467 A1
(43) Pub. Date: Jul. 19, 2007

(54) Process for reducing surface aberrations

(76) Inventors: David J. Smith, Topsfield, MA (US); Michael C. Andrews, Beverly, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/561,209

(22) PCT Filed: Jun. 16, 2004
(86) PCT No.: PCT/US04/19187

§ 371 Date: Feb. 8, 2007

Related U.S. Application Data
(60) Provisional application No. 60/480,014, filed on Jun. 20, 2003.

(51) Int. Cl. B29C 47/00; B29C 47/76

(52) U.S. Cl. 264/102; 264/176.1; 264/564; 526/348.1

(57) ABSTRACT

The processes and resins of the present invention allow the extrusion of polymer products, such as polymer films, that have a reduced occurrence of surface aberrations, e.g., surface melt fracture and/or haze bands and/or haze. Preferably, the polymer products produced in accordance with the present invention are substantially free of surface aberrations even when manufactured under conditions of high sheer stress such as those conditions that occur at commercial production rates. In part, the present invention provides processes for polymer extrusion wherein the resins employed are treated using heat in an atmosphere sufficient to substantially eliminate the tendency to create surface aberrations. The resins can have reduced or substantially eliminated concentrations of low molecular weight components. In some embodiments, both the polymer resins and the extruded polymer products have reduced concentrations of processing aid(s), e.g., the polymer resins and the extruded polymer products are substantially free of processing aid(s).

### RELATED APPLICATION

This application claims the benefit of U.S. Provisional Application No. 60/480,014, filed Jun. 20, 2003, the entire contents of which are incorporated herein by reference.

### BACKGROUND OF THE INVENTION

Generally, processes for the extrusion of polymers are well-known in the art. The two principal components of an apparatus for the extrusion of polymers are the extruder and the die. Typically, polymer resin, often in pellet form, is fed to the extruder which then melts the polymer and subsequently conveys the polymer melt to the die. The polymer melt is forced through the die to shape the polymer melt into the desired form. The formed polymer melt, or extrudate, is then either further processed or cooled in its final form.

Polymer films have commonly been formed using extrusion processes. Examples of well-known processes for forming polymer films include, but are not limited to, blown film extrusion and cast film extrusion. Many varied polymer films can be produced by such processes. Polymer films usually are made of thermoplastic polymers such as, for example, polyethylene or polypropylene. Furthermore, polymer films may comprise more than one type of polymer either as a blend of polymers or as layers of distinct polymer composition.

As is recognized in the art, it is currently difficult, if not impossible, to produce acceptable blown linear low density polyethylene (LLDPE) polymer films at commercial rates without either including additives or modifying the processing equipment (e.g., larger die gaps) and/or processing conditions (e.g., higher melt temperatures) from what would be the preferred configuration and/or processing conditions. Processing aids such as, for example, fluoropolymers are commonly added to LLDPE polymers used to produce blown polymer films. These processing aids, while typically helping to reduce the occurrence of surface melt fracture, add cost and have an adverse influence on some films by making these films more difficult to adhere to other products (e.g., inks). Some blown polymer films produced from polymer melts containing processing aids still contain a fine surface roughness that compromises optical clarity, known as surface haze.

### SUMMARY OF THE INVENTION

The processes and resins of the present invention allow the extrusion of polymer products, such as polymer films, that have a reduced occurrence of surface melt fracture and haze. In one embodiment, practice of the present invention will substantially eliminate the finely scaled narrow bands of optical surface defects known as haze bands in polymer products. In another embodiment, practice of the present invention will substantially eliminate the finely scaled optical surface defects known as surface haze. Preferably, the polymer products produced using the processes and/or polymer resins described herein are substantially free of surface melt fracture and/or haze bands and/or surface haze even when manufactured under conditions of high shear stress such as those conditions that occur at commercial production rates. In part, the present invention provides processes for treating polymers to substantially eliminate melt fracture, surface haze and/or haze bands during film or other types of extrusion without the use of processing aids or modification of the extrusion equipment and/or process conditions.

The present invention is directed, in part, to processes for substantially eliminating the occurrence of surface aberrations, for example, surface melt fracture and/or haze bands and/or surface haze, during extrusion of a polymer without using processing aids. In one embodiment, the polymer is a thermoplastic polymer, e.g., linear low density polyethylene (LLDPE), and the process comprises (a) providing a thermoplastic polymer resin that has been treated by the application of heat in an atmosphere sufficient to substantially eliminate the tendency to create melt fracture, haze bands and/or surface haze during extrusion, for example, by providing a thermoplastic polymer resin that has been treated; and (b) extruding the treated thermoplastic polymer resin through a die wherein the extrusion conditions are such that the process would otherwise produce surface melt fracture and/or haze bands and/or surface haze, thereby producing an extruded thermoplastic polymer product in which surface melt fracture and/or haze bands and/or surface haze are substantially eliminated.

In another embodiment, the present invention provides a process for producing a blown film polymer product having reduced occurrence of surface melt fracture and/or haze bands and/or surface haze wherein the process comprises (a) heating a polymer resin in an atmosphere for a time sufficient to substantially eliminate the tendency to create melt fracture, haze bands and surface haze during extrusion; and (b) forming a blown film polymer product, having reduced occurrence of surface melt fracture and/or haze bands and/or surface haze, from said polymer resin by extrusion through a die; wherein the extrusion conditions are such that the process would otherwise produce surface melt fracture and/or haze bands and/or surface haze and wherein a processing aid is not required to form commercial quality film.

A process for producing a thermoplastic film is also provided wherein the process comprises (a) polymerizing ethylene to produce linear low density polyethylene; (b) treating the linear low density polyethylene, by the application of heat in an atmosphere for a time sufficient to substantially eliminate the tendency to create melt fracture, haze bands and surface haze during extrusion; and (c) extruding the product of step (b) through a die to produce a thermoplastic film, and wherein the resulting thermoplastic film is substantially free of melt fracture and/or haze bands and/or surface haze, and wherein the extrusion conditions are such that the process would otherwise produce surface melt fracture and/or haze bands and/or surface haze.

Without wishing to be held to any particular theory, it is believed that the heat and atmosphere treatment reduces the content of low molecular weight species in the polymer resin and it is these species that are responsible for the surface melt fracture, haze bands and/or surface haze. Therefore, the invention is also directed to a process for substantially eliminating surface aberrations, e.g., surface melt fracture and/or haze bands and/or surface haze, during extrusion of a thermoplastic polymer, comprising extruding the thermoplastic polymer through a die wherein the thermoplastic polymer is substantially free of low molecular weight compounds.

Furthermore, the invention comprises a process for reducing the occurrence of melt fracture and/or haze bands and/or surface haze in thermoplastic films under conditions of extrusion flow rate and temperature that would otherwise produce melt fracture and/or haze bands and/or surface haze. The process comprises (a) providing a thermoplastic polymer resin that has been treated by the application of heat in an atmosphere for a time sufficient to substantially eliminate the tendency to create melt fracture, haze bands and/or surface haze during extrusion, for example, by substantially removing low molecular weight components; and (b) extruding the treated thermoplastic polymer resin through a die wherein the resin is mixed prior to exit of the resin from the die and wherein the extrusion conditions are such that the process would otherwise produce surface melt fracture and/or haze bands and/or surface haze, thereby producing an extruded thermoplastic polymer film in which surface melt fracture and/or haze bands and/or surface haze are substantially eliminated.

Thermoplastic polymer resins that have been treated after polymerization are also encompassed in the scope of the present invention. Specifically, (1) a linear low density polyethylene extrusion resin for film extrusion comprising polyethylene that has been treated by the application of heat and atmosphere for a time sufficient to substantially eliminate the tendency to create melt fracture, haze bands and/or surface haze during extrusion of the resin after polymerization and pelletization, (2) a linear low density polyethylene extrusion resin for film extrusion comprising polyethylene that has been treated by the application of heat and atmosphere for a time sufficient to substantially eliminate the tendency to create surface melt fracture, haze bands and/or surface haze during extrusion of the resin after polymerization but before pelletization, and (3) a thermoplastic polymer resin wherein the resin has been treated by the application of heat and atmosphere, are contemplated herein.

Additional resins encompassed by the present invention including, (1) a linear low density polyethylene extrusion resin for film extrusion comprising polyethylene that is substantially free of low molecular weight species, and (2) a thermoplastic polymer resin normally susceptible to the aforementioned problems with surface melt fracture, haze bands and/or surface haze wherein the resin is substantially free of low molecular weight species, are contemplated herein.

Thermoplastic polymer films can be produced by practicing any of the inventive processes described herein. The thermoplastic films produced by these methods are substantially free of surface melt fracture and/or haze bands and/or surface haze. Preferably, the thermoplastic polymer films are produced from polymer melts that are substantially free of processing aids.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a typical blown polymer film extrusion process.

FIG. 2 is a cross-section of a single layer blown polymer film.

FIG. 3 is a cross-section of a three layer blown polymer film.

FIGS. 4A and 4B are gas chromatographs identifying low molecular weight species present in a common LLDPE polymer resin.

### DETAILED DESCRIPTION OF THE INVENTION

For purposes of this description of the present invention, the following definitions apply:

A polymer is “susceptible to surface melt fracture” if it produces film with substantial surface melt fracture, as judged by the unaided eye, when extruded through a tubular film die having a 0.055 inch (about 1.4 mm) die gap at 400° F. (about 204° C.) and 12 lbs/hr/inch of die circumference (about 2.14 kg/hr/cm of die circumference).

A polymer is “susceptible to haze bands” if it produces film with substantial haze bands, as judged by the unaided eye, when extruded through a tubular film die having a 0.055 inch (about 1.4 mm) die gap at 400° F. (about 204° C.) and 12 lbs/hr/inch of die circumference (about 2.14 kg/hr/cm of die circumference), said polymer not having been treated by the application of heat and atmosphere, e.g., to remove low molecular weight species, and said polymer containing a processing aid in sufficient quantity to substantially eliminate surface melt fracture.

A polymer is “susceptible to surface haze” if it produces film with substantial surface haze, as judged by the unaided eye, when extruded through a tubular film die having a 0.055 inch (about 1.4 mm) die gap at 400° F. (about 204° C.) and 12 lbs/hr/inch of die circumference (about 2.14 kg/hr/cm of die circumference), said polymer not having been treated by the application of heat and atmosphere, e.g., to remove low molecular weight species, and said polymer containing a processing aid in sufficient quantity to substantially eliminate surface melt fracture.

A polymer fitting the definitions above is “sufficiently treated with heat and atmosphere” when, after treatment with heat and atmosphere, it is used to produce a polymer film substantially free of surface melt fracture and/or haze bands and/or haze, as judged by the unaided eye, when extruded through a tubular film die having a die gap of 0.055 inch (about 1.4 mm) die gap at 400° F. (about 204° C.) and 12 lbs/hr/inch of die circumference (about 2.14 kg/hr/cm of die circumference).

The term “processing aid,” as used herein, refers to materials present in polymer resins or blended with polymer resin pellets to assist in reducing surface melt fracture that may occur during processing at commercial rates of polymer film production. Processing aids include those materials known by those skilled in the art to reduce surface melt fracture during the formation of thermoplastic polymer films. Processing aids typically allow the production of acceptable thermoplastic products at higher shear rates and lower temperatures than would be possible without the presence of processing aids. Examples of processing aids used to eliminate surface melt fracture include fluoropolymers, such as polytetrafluoroethylene and fluoroelastomers (e.g., VITON® fluoroelastomer (DuPont Dow Elastomers, L.L.C., Wilmington, Del.)).

The term “surface aberration,” as used herein, refers to surface defects that are commonly seen on LLDPE films, including surface melt fracture, haze bands and surface haze as defined herein. Films having surface melt fracture and/or haze bands and/or surface haze are described herein as containing surface aberrations.

“Haze band,” as that term is used herein, refers to a general class of surface defects found in polymer films, e.g., blown or cast film thermoplastics. Haze bands are generally characterized by small scale surface roughness that extends in the direction of extrusion (i.e., the bands of surface roughness are aligned in the machine direction).

“Surface haze,” as that term is used herein, refers to an overall surface defect characterized by small scale surface roughness that can be, for example, more or less uniformly distributed over the entire surface of the film, e.g., not just in particular bands.

“Haze,” as that term is used herein, refers to surface haze, as opposed to through thickness or internal haze typically associated with, for example, crystallinity. The surface roughness associated with haze is on a scale such that the individual defects causing the roughness are typically not visible to the unaided human eye, but the effect of the roughness is to degrade the optical properties of the surface. One method for measuring haze of a polymer film is outlined in ASTM D1003 “Standard Test Method for Haze and Luminous Transmittance of Transparent Plastics” (ASTM International, West Conshohocken, Pa.). For example, a BYK Gardner Haze-Gard Plus (Catalog No. 4725, BYK-Gardner USA, Columbia, Md.) is used to measure the haze content of a blown polymer film.

“Surface melt fracture,” as referred to herein, is a condition of the surface of a polymer film characterized by substantial roughness, e.g., on a scale that is typically visible to the unaided human eye.

Films described herein as having “acceptable commercial properties” are films that are satisfactory in the trade for their intended purposes. The absolute amounts of melt fracture, haze bands and haze that are permissible will vary depending upon the end use.

The term “substantially free of low molecular weight species,” as used herein, refers to a polymer, e.g., treated in accordance with the present invention, wherein the polymer contains only trace amounts of low molecular weight species. A polymer suitable for extrusion of polymer products, as described herein, e.g., a polymer substantially free of low molecular weight species, has only a slight odor when the resin is held in an enclosed container for more than 24 hours. It should be noted that commercial LLDPE polymers have a strong odor when their containers are opened.

The terms “low molecular weight components,” “low molecular weight species,” and “low molecular weight compounds,” as used herein, refer to low molecular weight species including water, atmospheric gases (e.g., nitrogen and oxygen gas, among others), and organic solvents, monomers, comonomers and their derivatives having carbon chains of 12 or fewer carbon atoms in length.

Polymer films are commonly produced by various polymer extrusion processes, for example, by the blown film process or by the cast film process. The extrusion processing conditions and resin can have significant influence on the characteristics and quality of the resultant polymer films. Without wishing to be held to any particular theory, it is believed that the composition, specifically the presence of low molecular weight species, of the polymer resins used in an extrusion process also influences the characteristics and quality of polymer film thus produced. Relevant characteristics of a polymer film depend, in part, on the intended application for the film but can include mechanical strength, optical quality (e.g., degree of haze, gloss and clarity), coloration, the ability to print the film, smoothness of the surface, and pliancy, among others.

During extrusion of polymer films, e.g., thermoplastic films and particularly linear low density polyethylene films, a phenomenon referred to by those skilled in the art as “surface melt fracture” can occur. Surface melt fracture is characterized by substantial roughness in the surface of the produced film. Polymer films with surface melt fracture have a poor appearance and can have a reduction in mechanical strength. Surface melt fracture can vary in degree. For example, a product may show just moderate roughness, or it may be severely distorted and irregular.

Several methods for reducing or eliminating surface melt fracture are utilized in the industry. One common method used by film producers for eliminating surface melt fracture is the addition of a processing aid to the polymer melt or by using polymer resins already containing a processing aid. Other common methods include the use of a larger die gap, increasing the melt temperature, reducing the flowrate, blending with other resins that are not as susceptible to surface melt fracture, or various combinations thereof. In the absence of processing aid or other modifications such as those mentioned above, surface melt fracture typically occurs at commercial rates of film production, e.g., under conditions of high shear stress. It is commonly accepted that shear stress levels at the die lip of commercial annular blown film dies on the order of about 19 pounds per square inch (psi) (about 131 kilopascals (kPa)) for octene-based LLDPE, about 18 psi (about 124 kPa) for hexene-based LLDPE and about 17 psi (about 117 kPa) for butene-based LLDPE will produce the onset of melt fracture. Conventionally, the presence of processing aid in a polymer melt can help to minimize surface melt fracture even under conditions of high shear stress in the lips of an extrusion die.

While the addition of processing aid to a polymer melt reduces or eliminates severe surface melt fracture under extrusion conditions (e.g., at a particular shear stress and temperature) that would otherwise produce surface melt fracture, areas of fine surface roughness, commonly referred to as “haze” or “haze bands,” are often produced in the polymer films. Thus, while the presence of processing aid in a polymer melt may help to reduce the severe type of surface melt fracture often produced during extrusion, polymer films thus made nevertheless often contain areas of very fine surface roughness, e.g., “haze” or “haze bands” as noted above. Microscopic examination of haze bands of some polymer films has revealed surface defects, for example, pits and gouges, while areas of the same films that are free of haze bands do not contain these surface defects. For the purpose of clarity, throughout this application the terms “haze” and “haze bands” refer to surface haze and not the through thickness haze, e.g., haze commonly associated with crystallinity (also known as internal haze).

Areas of a polymer film lying within a haze band are degraded optically compared to areas of a polymer film that do not lie within a haze band. It is believed that haze bands vary in width depending on the material being extruded and the processing conditions such as temperature, flow rate, and shear stress. The present inventors have found that haze bands commonly occur in thermoplastic film that has been extruded from polymer melts containing processing aid and at commercial rates of production. Because processing aid has been added to the polymer, the film producer will normally be expected to produce the blown film in such a way that the shear stress at the die lips will be above the above-described shear stress levels that would be expected to cause surface melt fracture. The present invention is not restricted to processes operating at or near this shear stress level, but rather at any shear stress that will produce melt fracture in a susceptible resin. Haze bands are generally considered to detract from the appearance of the polymer film.

One skilled in the art will recognize that the occurrence of haze and haze bands differs from surface melt fracture in the degree of roughness and irregularity. While films having surface melt fracture are generally distorted and irregular, films having haze and haze bands generally have surface roughness exemplified by degradation of optical properties. Films having haze bands may also exhibit reduced mechanical strength in the areas of the haze bands. The mechanical strength of a film having haze bands can be reduced with respect to impact strength, tensile strength, tear resistance, and puncture resistance, among others.

The present invention is directed, in part, to processes for substantially eliminating the occurrence of surface aberrations during extrusion of a thermoplastic polymer. In one embodiment, the process comprises (a) providing a thermoplastic polymer resin that has been treated by the application of heat and atmosphere; and (b) extruding the treated thermoplastic polymer resin through a die wherein the extrusion conditions are such that the process would otherwise produce surface aberrations, thereby producing an extruded thermoplastic polymer product in which surface aberrations are substantially eliminated. The present invention is also directed to processes for producing polymer products having reduced or substantially eliminated occurrence of surface aberrations wherein a processing aid is not required to form the polymer products. In one embodiment, the present invention provides a process for producing a blown film polymer product having reduced occurrence of surface aberrations wherein the process comprises (a) heating a polymer resin in an atmosphere; and (b) forming a blown or cast film polymer product having reduced occurrence of surface aberrations, from said polymer resin; wherein a processing aid is not required to form the film polymer product having acceptable commercial properties.

The invention also includes a process for producing a blown film polymer product having reduced occurrence of surface aberrations comprising (a) heating a polymer resin in an atmosphere to remove low molecular weight components; and (b) forming a film polymer product having reduced occurrence of surface aberrations from said polymer resin; wherein a processing aid is not required to form the blown film polymer product.

In one aspect, the present invention is directed to a linear low density polyethylene extrusion resin for blown film extrusion comprising polyethylene that is substantially free of low molecular weight species. In one embodiment, the linear low density polyethylene resin is substantially free of processing aid. In one embodiment, the linear low density polyethylene resin is formed, e.g., manufactured, polymerized, compounded, reacted, or mixed, using a process that results in the resin being substantially free of low molecular weight species. Alternatively, the invention is also directed to a thermoplastic resin wherein the resin has been treated by the application of heat and atmosphere for a time sufficient to substantially eliminate the tendency to create surface aberrations during extrusion of the resin, e.g., to remove low molecular weight compounds. For example, a linear low density polyethylene resin is provided wherein the low molecular weight species are substantially removed from the resin. Low molecular weight species can be removed from the resin by any of a number of means that are well-known in the art, e.g., heating and/or vacuum.

In one aspect of the invention, a polymer resin, e.g., a thermoplastic polymer resin, is provided wherein the resin has been treated to substantially remove low molecular weight components. Preferably, the polymer resin has been treated to remove a sufficient quantity of low molecular weight components such that when the polymer resin is extruded through a die under conditions that would otherwise produce surface melt fracture, an extruded polymer product is produced wherein surface aberrations are substantially eliminated, e.g., a polymer product is produced that is substantially free of surface aberrations.

In one facet of the present invention, a polymer resin that has been treated to substantially remove low molecular weight components is provided. The treated polymer resin may be supplied as a treated commercial resin or may be produced from a conventional resin. Methods of removing low molecular weight species from a polymer are well-known in the art. Examples of techniques for removing low molecular weight species from a polymer include, but are not limited to, heating, vacuum treatment, and modified manufacturing/polymerization processes. This process can comprise elevating the temperature of the resin and/or reducing the environmental air pressure. The temperature of the resin should remain elevated long enough for the required quantity of low molecular weight components to leave the resin, such as, for example, about 1 to 8 hours for resin pellets. In a preferred embodiment, the resin is heated for a period of time sufficient to remove a quantity of low molecular weight components such that when the resin is extruded the resulting product has a reduced or substantially eliminated occurrence of surface melt fracture. One skilled in the art can select appropriate temperatures, pressures, and periods of time to remove low molecular weight components without undue experimentation. For example, the polymer resin, e.g., a solution phase LLDPE, can be treated by heating (at atmospheric pressure) at a temperature of at least about 130° F. (54.4° C.) for at least about 4 hours. The polymer resin can be treated by heating (at atmospheric pressure) at a temperature of about 130° F. (54.4° C.) to about 160° F. (71.1° C.) for about 4 hours to about 60 hours, e.g., for about 4 hours to about 48 hours or about 24 hours to about 48 hours.

Alternatively, a process for producing a polymer film from resins susceptible to surface aberrations is provided comprising extruding the polymer through a die using an extrusion apparatus such that during extrusion the polymer is treated with sufficient heat and atmosphere to substantially eliminate its susceptibility to create surface aberrations prior to the resin exiting the die, thereby producing a polymer film that is substantially free of surface aberrations; wherein the polymer resin and the resulting extruded polymer are free of processing aid. For example, a vented extrusion apparatus may be employed to produce a polymer film, e.g., a thermoplastic polymer film, wherein the vented extrusion apparatus is used to treat the polymer resin with heat and atmosphere to partially eliminate its susceptibility to surface aberrations prior to extrusion through a die. In one embodiment, a non-vented extrusion apparatus equipped with a vacuum hopper can be used.

Preferably, the polymer resin is selected from the group consisting of linear low density polyethylene, metallocene catalyzed polyethylene and combinations thereof. Thus in one aspect, the invention is directed to a process for reducing the occurrence of haze bands in thermoplastic films under conditions of extrusion flow rate and temperature that would otherwise produce haze bands, the process comprising (a) providing a thermoplastic polymer resin that has been treated by the application of heat and atmosphere, e.g., to substantially remove low molecular weight components; and (b) extruding the treated thermoplastic polymer resin through a die wherein the resin is mixed prior to exit of the resin from the die and wherein the extrusion conditions are such that the process would otherwise produce surface aberrations, thereby producing an extruded thermoplastic polymer film in which surface aberrations are substantially eliminated. Preferably, the concentration of the low molecular weight species is substantially uniform throughout the thermoplastic polymer resin prior to exit of the resin from the die. The resin in such a process is preferably substantially free of processing aid.

Thermoplastic polymer films can be produced by a process for substantially eliminating surface aberrations during extrusion of a thermoplastic polymer wherein the process comprises extruding the thermoplastic polymer through a die wherein the thermoplastic polymer has been treated by the application of heat and atmosphere, e.g., to substantially remove low molecular weight compounds, and is substantially free of processing aid. In one embodiment, thermoplastic polymer films are produced by a process for substantially eliminating the occurrence of surface aberrations during extrusion of a thermoplastic polymer wherein the process comprises (a) providing a thermoplastic polymer resin that has been treated by applying heat and atmosphere; and (b) extruding the treated thermoplastic polymer resin through a die wherein the extrusion conditions are such that the process would otherwise produce surface aberrations, thereby producing an extruded thermoplastic polymer product in which surface aberrations are substantially eliminated; wherein the thermoplastic polymer resin and the resulting extruded thermoplastic polymer are substantially free of processing aid.

In one aspect, the invention is also directed to the thermoplastic polymer films produced using the polymer resins and methods described herein. For example, the invention includes the thermoplastic polymer film produced by a process for substantially eliminating the occurrence of surface aberrations during extrusion of a thermoplastic polymer. In one embodiment, the process comprises (a) providing a thermoplastic polymer resin that has been treated by applying heat and atmosphere; and (b) extruding the treated thermoplastic polymer resin through a die wherein the extrusion conditions are such that the process would otherwise produce surface aberrations, thereby producing an extruded thermoplastic polymer product in which surface aberrations are substantially eliminated. In another embodiment, the thermoplastic polymer resin and the resulting extruded thermoplastic polymer are substantially free of processing aid. In yet another embodiment, the process comprises extruding the thermoplastic polymer through a die wherein the thermoplastic polymer is substantially free of low molecular weight compounds and processing aid.

In one specific embodiment, the invention includes an extruded thermoplastic polymer film comprising a thermoplastic polymer resin wherein the extruded thermoplastic polymer film is substantially free of low molecular weight species and substantially free of surface aberrations and wherein the film is substantially free of processing aid.

In one embodiment, resin treatment used in the current invention comprises heating the resin to a selected temperature and holding the resin at the selected temperature for a period of time. In preferred embodiments, throughout the treatment process the resin is in an essentially inert atmosphere. For example, in one embodiment, the resin can be held in a vacuum environment throughout the treatment process. Operative temperatures are typically in the range of about 100° F. (about 37.8° C.) to the temperature at which slight softening and sticking of the resin will occur. Temperatures in the range of about 150° F. (about 65.6° C.) to about 160° F. (about 71.1° C.) have been shown to give acceptable results. The time periods for treatment will vary, and are dependent upon both the selected temperature and the particle size of the polymer resin undergoing treatment. For conventional pelletized resins, e.g., commercial solution phase LLDPE polymer resins, treatment times in the range of about 4 to about 100 hours have been used, with preferred treatment periods in the range of about 8 to about 24 hours. The atmosphere surrounding the resin during treatment should be one that will not cause significant degradation of the resin during treatment. Depending on the resin, this atmosphere can be, for example, a flowing gas stream or a vacuum. In one preferred embodiment, the partial pressure of the low molecular weight species is kept at a low level. An air atmosphere is a preferred embodiment for solution phase polymerized resins, although other atmospheres such as nitrogen, other inert gases, or vacuum also can be used.

Resin treatment in accordance with the present invention may be performed in a number of different ways. For example, a resin dryer (e.g., a hopper dryer) can be used to remove low molecular weight species from the resin, either prior to or following pelletization. In one embodiment, low molecular weight species are removed from the resin by passing a stream of gas through the thermoplastic polymer resin either prior to or following pelletization. For example, a stream of gas can be passed through containers typically used to hold or store thermoplastic polymer resin prior to extrusion into thermoplastic products. The gas directed through the resin can be, for example, air or an inert gas. Preferably, the stream of gas contains a lower concentration of one or more low molecular weight species than the concentrations of those same species that are present in the space near the resin particles. In one embodiment, the stream of gas is heated before the gas is passed through the polymer resin.

In one embodiment, a storage silo or resin hopper, such as those typically used at manufacturing facilities to hold polymer resin prior to use, is fitted with a gas distribution apparatus whereby a stream of gas is directed through the resin contained therein. Thus, low molecular weight species can be removed from the polymer resin while the resin is contained in a storage silo or resin hopper. Preferably, migration of one or more low molecular weight species from the polymer resin is encouraged by keeping the concentration of low molecular weight species in the gas stream at low levels. In one embodiment, the gas stream is substantially free of low molecular weight species. In one embodiment, the temperature of the gas stream and/or resin is lower than the temperature of the atmosphere and/or resin when a resin dryer such as a hopper dryer is used to remove the low molecular weight species. For example, low molecular weight species can be removed from the resin at lower temperatures and over longer periods of time than those that typically would be used when a resin dryer such as a hopper dryer is employed. In one embodiment, the resin can be stored under an at least partial vacuum or under an inert atmosphere prior to extrusion into thermoplastic products. For example, the resin can be stored under at least partial vacuum in vacuum rated vessels prior to extrusion into thermoplastic products.

In some embodiments, low molecular weight species are removed from a thermoplastic polymer resin by heating the resin to a temperature less than the melting point of the thermoplastic polymer resin. As described supra, in some embodiments, a portion of, or substantially all, low molecular weight species can be removed from a thermoplastic polymer resin using a vented extruder such as wherein a vacuum is drawn on a flowing resin mass following melting. In one embodiment, a vacuum can be applied at a feed throat of an extruder to draw low molecular weight species from the resin as the resin is compacted and melted in the extruder. For example, a vacuum hopper or another vacuum apparatus can be used to apply a vacuum at the feed throat of an extruder.

In some embodiments, the polymer resin is treated just prior to extrusion. However, in other embodiments, there are advantages gained by treating the polymer resin prior to pelletization. For example, during processing at a resin manufacturing plant, there are several convenient opportunities for treating resins according to the present invention. In addition, by treating the polymer resin at a resin manufacturing plant, capital, labor and operating expenses of forming products from the resin can be reduced at the point of resin use.

Resins produced by solution phase polymerization processes, e.g., solution phase linear low density polyethylene, are typically discharged from resin production processes as a liquid, or molten, resin. In one embodiment, low molecular weight components are removed from the liquid resin by treating the liquid resin with vacuum prior to pelletization of the resin. Low molecular weight components also can be removed by sparging the liquid resin with an inert gas medium.

Resins produced by gas phase polymerization processes, e.g., gas phase linear low density polyethylene, are typically discharged from resin production processes as granular solid resin. Granular solid resin is then typically pelletized. In one embodiment, low molecular weight components are removed from the granular solid resin by conducting the pelletization under vacuum. For example, the pelletization process can include extrusion through a vented extruder or through an apparatus that comprises a vacuum feed throat as described infra.

In one embodiment, the treated thermoplastic polymer is substantially in the form of resin pellets. In one embodiment, substantially all of the mass of the polymer is in pellet form. For example, at least about 80 weight percent of the polymer can be contained in pellet form.

Practice of the present invention provides several advantages. The present invention provides processes for the production of polymer products wherein the polymer products have a reduced occurrence of surface melt fracture. In preferred embodiments, the occurrence of surface aberrations in the polymer products is substantially eliminated. Polymer products that have a reduced or substantially eliminated occurrence of surface aberrations can have improved properties such as, for example, increased mechanical strength, improved optical properties and improved surface gloss. Additionally, practice of the present invention allows the extrusion of polymer products, such as polymer films, using processes that do not require the presence of processing aids in the polymer melt or in the final products. Polymer products that do not require the presence of processing aid during manufacture, such as those described herein, can have reduced manufacturing costs including materials, capital, and labor costs.

Furthermore, practice of the invention allows the commercial-scale production of polymer products, such as polymer films, that are substantially free of surface aberrations while not requiring the use of processing aid. Commercial-scale production of polymer products, e.g., polymer films, typically involves high throughput of polymer materials and is accompanied by high shear stress in the extrusion die which makes production of quality polymer film challenging. Advantageously, practice of the invention can allow the production, at acceptable commercial flow rates, of the above-mentioned improved polymer products at lower polymer melt temperatures and die temperatures. The use of lower polymer melt and die temperatures can result in increased rates of production and reduced polymer thermal degradation. Practice of the present invention is also expected to result in a reduction of polymer build-up on the die lips during production runs. Less polymer build-up on the die lips allows longer process run times and can further reduce manufacturing costs.

Polymer melts are subjected to shear forces as they are pushed to and through a film die. Generally, polymer melts exhibit shear-thinning non-Newtonian flow behavior. As the shear rate is increased on a polymer melt, the viscosity of the melt decreases. The degree of shear-thinning is dependent upon the polymer's molecular weight, the molecular weight distribution, and molecular configuration. Without being held to any particular theory, it is believed that the local surface concentration of low molecular weight species at the exit of the die lips is a cause of surface aberrations in blown film comprising LLDPE and related polymers, e.g., metallocene LLDPE (mLLDPE). It is likely that low molecular weight species migrate to high shear stress areas within the extrusion die and subsequently worsen the surface defects known as haze and surface melt fracture. We believe the process of this invention reduces the content of low molecular weight species in the polymer and we believe these species can be the primary contributor to the described surface aberrations. Polymers treated with sufficient heat and atmosphere have much less odor than the original resin, and some low molecular weight species can be a source of odor, so it can be deduced that the content of low molecular weight species in the resin is greatly reduced by the treatment process described herein.

The processes provided by the instant invention can be applied to the extrusion of polymer resins that are otherwise subject to the occurrence of surface melt fracture as described herein. Polymer resins suitable for use in the present invention include linear low density polyethylene and other similar polymers, including metallocene catalyzed polyethylene. The processes of the invention are particularly suitable for the extrusion of thermoplastic polymer resins. In preferred embodiments, the thermoplastic polymer resins comprise linear low density polyethylenes. The present invention demonstrates that conventional thermoplastic polymer resins comprising linear low density polyethylenes are subject to the formation of surface melt fracture under commercial production conditions. Conventional thermoplastic resins comprising linear low density polyethylenes, sometimes experience the formation of haze bands under commercial production conditions even when the polymer melt includes one or more processing aids. The polymer resins suitable for use in the processes of the instant invention may also comprise additives commonly used in the manufacture of polymer products such as, for example, thermoplastic films. Suitable additives include plasticizers, fillers, pigments, slip agents, anti-block agents and the like. Specifically, agents which themselves contain low molecular weight species (e.g., slip agents) will preferably be similarly treated to remove those species which contribute to surface aberrations.

Techniques for polymer extrusion suitable for use in the current invention include, but are not limited to, blown film extrusion, cast film extrusion, extrusion coating, sheet extrusion, vented extrusion, coextrusion, and single and multiple screw extrusion. Furthermore, one skilled in the art will recognize that the principles of the present invention may also be applied to any of a number of other processes for the formation of polymer films. Any of several types of extrusion dies known in the art may be employed in practicing the present invention. Examples of suitable extrusion dies include, but are not limited to, annular dies, spiral annular dies, flat plate dies, slit dies, and coextrusion dies.

In one preferred embodiment, the treated thermoplastic polymer resin is extruded through a die using a blown film extrusion process. Generally, blown film extrusion processes are well-known to those of ordinary skill in the art. Typically, in a blown film extrusion process, an extruder (e.g., a smooth bore extruder) is used to force molten polymer resin through an annular die and a polymer film tube emerging from the die is blown to a larger diameter by gas trapped within the tube. The polymer film tube can be subsequently flattened by a collapsing frame and a set of nip rolls that function to draw the tubular polymer film away from the annular die. This blown film extrusion process is also known in the art as tubular blown film extrusion.

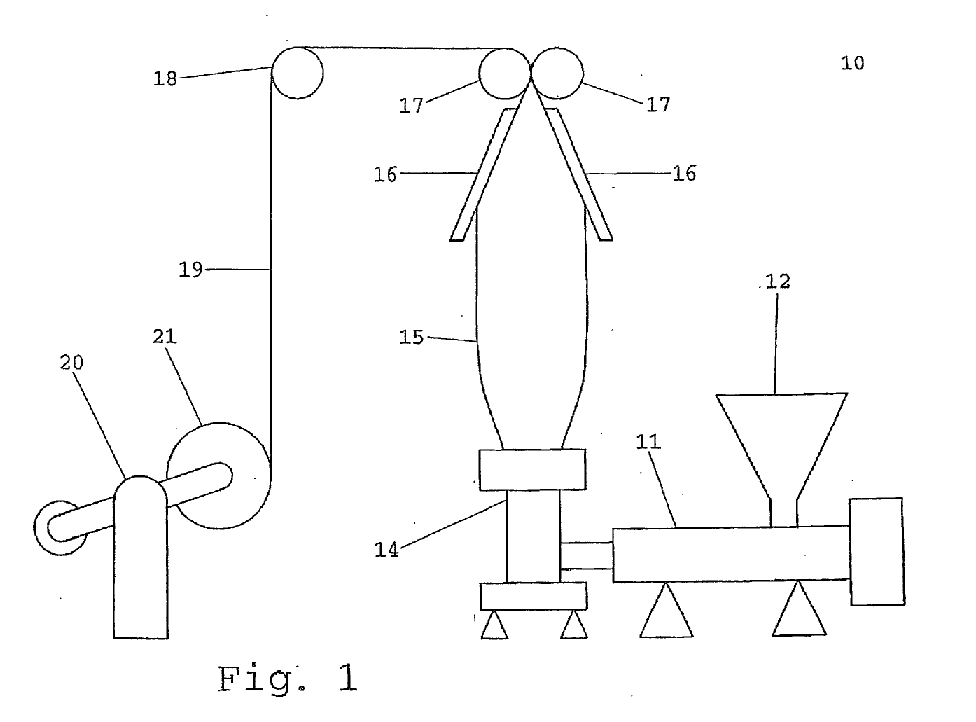

FIG. 1 illustrates typical blown polymer film extrusion process 10. Treated polymer resin is fed to polymer extruder 11 through extruder hopper 12. Additives, such as, for example, plasticizers, fillers, pigments, slip agents, and anti-block agents can be mixed with the polymer resin prior to introducing the resin to extruder hopper 12 or can be mixed with the polymer resin in extruder hopper 12. The polymer resin is melted, compressed and metered within extruder 11. Extruder 11 transfers the melted polymer resin under pressure to blown polymer film die and air ring apparatus 14. The melted polymer resin is forced through blown polymer film die and air ring apparatus 14 producing polymer film bubble 15. In one embodiment, the polymer film die is structured to produce a single layer blown polymer film bubble. In other embodiments, the polymer film die is structured to form a multi-layered blown polymer film bubble. The shape of polymer film bubble 15 is maintained, in part, by air supplied by the air ring component of blown polymer film die and air ring apparatus 14.

Some of the techniques known in the art for avoiding melt fracture are also applicable to the present invention, while others are not. For instance, the inventors have found that the streamlining of flow passages within the extrusion die of blown polymer film die and air ring apparatus 14 will produce noticeable improvements in the levels of melt surface aberrations. Additionally, we have found that decreases in melt temperature help to reduce melt fracture when using resins treated in accordance with the present invention, whereas the conventional knowledge of those skilled in the art suggests that, when using untreated resins, increases in melt temperature will help to minimize melt fracture. Lower melt temperatures produce advantages with respect to potentially increased rates and potential improvements in mechanical properties.

Typically, polymer film bubble 15 is stretched and cooled as it is conveyed to collapser frame 16. Collapser frame 16 collapses polymer film bubble 15 and directs the polymer film to nip roll 17. The blown polymer film is then directed around idler roller 18. Blown polymer film product 19 is wound by winder 20 on winding roll 21.

In another embodiment, the treated thermoplastic polymer resin is extruded through a die using a cast film process. Generally, the cast film extrusion process, as known to those of ordinary skill in the art, uses an extruder is used to force molten polymer resin through a straight slit die. Then, a thin polymer sheet film emerging from the die can be quenched by pinning the film against a cooled polished roll.

In one embodiment, the polymer melt is additionally mixed prior to exit of the polymer melt from the lips of the extrusion die. Means for mixing the polymer melt can be internal or external to the extrusion die. In one embodiment, one or more inline static mixers are incorporated into the channels of the extrusion die. For example, at least one inline static mixer can be used in each polymer stream that eventually leads to the die lips. In another embodiment, the polymer melt is mixed prior to entry of the polymer melt into the extrusion die. For example, the polymer melt can be mixed using a static mixer of flow inverter located in or adjacent to an adaptor and/or melt pipe conveying the polymer melt from the extruder to the die.

Without wishing to be held to any particular theory, it is believed that an improvement to producing extruded polymer films that have reduced or substantially eliminated occurrences of surface aberrations is to reduce or substantially eliminate local concentrations of low molecular weight components in a polymer melt. By mixing the polymer melt prior to exit of the polymer melt from the lips of the extrusion die, it is believed that low molecular weight components can be distributed more uniformly throughout the polymer melt and thereby reduce or substantially eliminate the occurrence of surface aberrations in the extruded product.

The processes and resins of the instant invention are directed to the production of polymer films having improved optical and mechanical characteristics when formed at commercial rates of production. For example, practice of the present invention can produce polymer film products having improved transparency. Polymer films can be produced using any of the processes or polymer resins described herein. The term “polymer film,” as used herein, refers to self-supporting materials comprising one or more polymeric materials. In a preferred embodiment, the polymer films are extruded. Polymer films generally range in thickness, for example, from about 10 microns to about 250 microns.

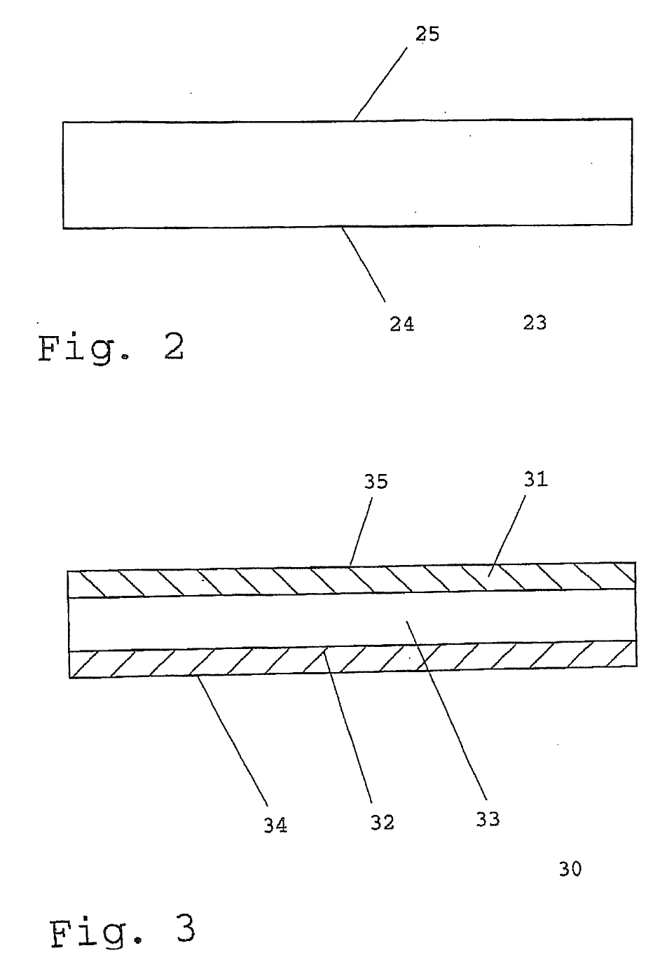

The polymer film produced by practicing the present invention is a single layer or a multi-layer polymer film. FIG. 2 shows a cross-section of single layer blown polymer film 23. Single layer blown polymer film 23 comprises inside surface 24 and outside surface 25. FIG. 3 shows a cross-section of three layer blown polymer film 30. The blown polymer film comprises outer polymer film layer 31, inner polymer film layer 32, and core polymer film layer 33. This multi-layer blown polymer film also comprises inside surface 34 and outside surface 35.

The thermoplastic polymer films produced using the polymer resins and methods described herein are single or multi-layered thermoplastic films. In preferred embodiments, the thermoplastic polymer films comprise a linear low density polyethylene. In one embodiment, multi-layer polymer films are produced using polymer resins, provided in accordance with the present invention, in only the outer, or skin, layers of the film.

The invention will now be illustrated with reference to the following non-limiting examples.

### EXEMPLIFICATION

Examples 1-5, infra, describe the production of three-layer blown polymer films. The films had an outer polymer film layer: core polymer film layer: inner polymer film layer ratio of 15:70:15 by weight. The outer and inner polymer film layers were produced using 2.5 inch (about 64 mm) diameter, 30/1 length/diameter smooth feed extruders (Contracool Extruders, Battenfeld Gloucester Engineering Co. Inc., Gloucester, Mass.). The core polymer film layer was produced using an 80 millimeter diameter, 30/1 length/diameter grooved feed extruder (Contracool Extruder, Battenfeld Gloucester Engineering Co. Inc., Gloucester, Mass.). With the exception of Examples 1 and 5, melted polymer was forced through a 3-layer extrusion die having a 16 inch (about 40.6 centimeter) diameter and a 0.080 inch (about 2 mm) die gap (die produced by Battenfeld Gloucester Engineering Co. Inc., Gloucester, Mass.) to form a multi-layer blown polymer film bubble. For Example 1, the die gap was 0.055 inches (about 1.4 mm). For Example 5, a die having a 0.055 inch (about 1.4 mm) die gap and also produced by Battenfeld Gloucester Engineering Co. Inc. was used. The polymer film bubble was collapsed, fed through a nip roller, and collected on a winding roll using a process similar to that shown in FIG. 1, described above.

The treated polymer resin of Examples 3-5 was treated in air by heating to the temperatures indicated. In other embodiments of the present invention, atmospheres other than air can be used. For example, vacuum or other atmospheres, e.g., inert gases such as nitrogen, and temperatures that will not produce significant resin degradation can be used. With certain polymer resins, particularly those resins produced by a gas phase polymerization process, vacuum is a preferred treatment atmosphere.

Examples 1-5, below describe experiments performed using a standard commercial configuration die. Other experiments used a die having a streamlined inner feed, and, as previously indicated, additional improvements in melt fracture, haze bands and haze were seen.

### Example 1

A three-layer blown polymer film was produced using DOWLEX™ 2045G octene copolymer linear low density polyethylene (LLDPE) (Dow Chemical Co., Midland Mich.). No processing aid was added to the polymer resin. The polymer resin was fed to the extruders at a total rate of 12 lb/hr/inch of die circumference (about 2.14 kg/hr/cm of die circumference). The extrusion temperature was 430° F. (about 221° C.) and the die gap was 0.055 inches (about 1.4 mm).

The resulting blown polymer film had severe surface melt fracture. Haze was not assessed due to the severe melt fracture.

### Example 2

A three-layer blown polymer film was produced using DOWLEX™ 2045G octene copolymer linear low density polyethylene (LLDPE) (Dow Chemical Co., Midland Mich.). 2% (w/w) processing aid was blended with the polymer resin prior to feeding the resin to the extruders for feed to the inner and outer layers. The polymer resin was fed to the extruders at a total rate of 12 lb/hr/inch of die circumference (about 2.14 kg/hr/cm of die circumference). The extrusion temperature was 430° F. (about 221° C.).

The resulting blown polymer film did not have visible surface melt fracture. Optical inspection of the polymer film revealed the presence of haze bands and surface haze.

### Example 3

A three-layer blown polymer film was produced using DOWLEX™ 2045G octene copolymer linear low density polyethylene (LLDPE) (Dow Chemical Co., Midland Mich.). No processing aid was added to the polymer resin. The polymer resin, however, was treated at 150° F. (about 66° C.) for 16 hours in a Una-Dyn Dehumidifying Hopper Dryer, Model DHD-30 (Universal Dynamics Corp., Woodbridge Va.). The resin was air cooled to room temperature following heat treatment. Polymer resin was fed to the extruders at a total rate of 12 lb/hr/inch of die circumference (about 2.14 kg/hr/cm of die circumference). Treated polymer resin was only supplied to the surface layers; untreated polymer resin was supplied to the core layer. The extrusion temperature was 400° F. (about 204° C.).

The resulting blown polymer film did not have visible surface melt fracture, haze bands or surface haze.

### Example 4

A three-layer blown polymer film was produced using DOWLEX™ 2045G octene copolymer linear low density polyethylene (LLDPE) (Dow Chemical Co., Midland Mich.). No processing aid was added to the polymer resin. The polymer resin, however, was treated at 150° F. (about 66° C.) for 16 hours in a Una-Dyn Dehumidifying Hopper Dryer, Model DHD-30 (Universal Dynamics Corp., Woodbridge Va.). Polymer resin was fed to the extruders at a total rate of 14.5 lb/hr/inch of die circumference (about 2.59 kg/hr/cm of die circumference). Treated polymer resin was only supplied to the surface layers; untreated polymer resin was supplied to the core layer. The extrusion temperature was 400° F. (about 204° C.).

The resulting blown polymer film did not have visible surface melt fracture or haze bands or surface haze.

### Example 5

A three-layer blown polymer film was produced using DOWLEX™ 2045G octene copolymer linear low density polyethylene (LLDPE) (Dow Chemical Co., Midland Mich.). No processing aid was added to the polymer resin. The polymer resin, however, was treated at 160° F. (about 71° C.) for 72 hours in a Una-Dyn Dehumidifying Hopper Dryer, Model DHD-30 (Universal Dynamics Corp., Woodbridge Va.). The resin was air cooled to room temperature following heat treatment. Polymer resin was fed to the extruders at a total rate of 12 lb/hr/inch of die circumference (about 2.14 kg/hr/cm of die circumference). Treated polymer resin was only supplied to the surface layers; untreated polymer resin was supplied to the core layer. The extrusion temperature was 400° F. (about 204° C.).

The resulting blown polymer film showed no evidence of surface melt fracture, haze bands or surface haze.

### Example 6

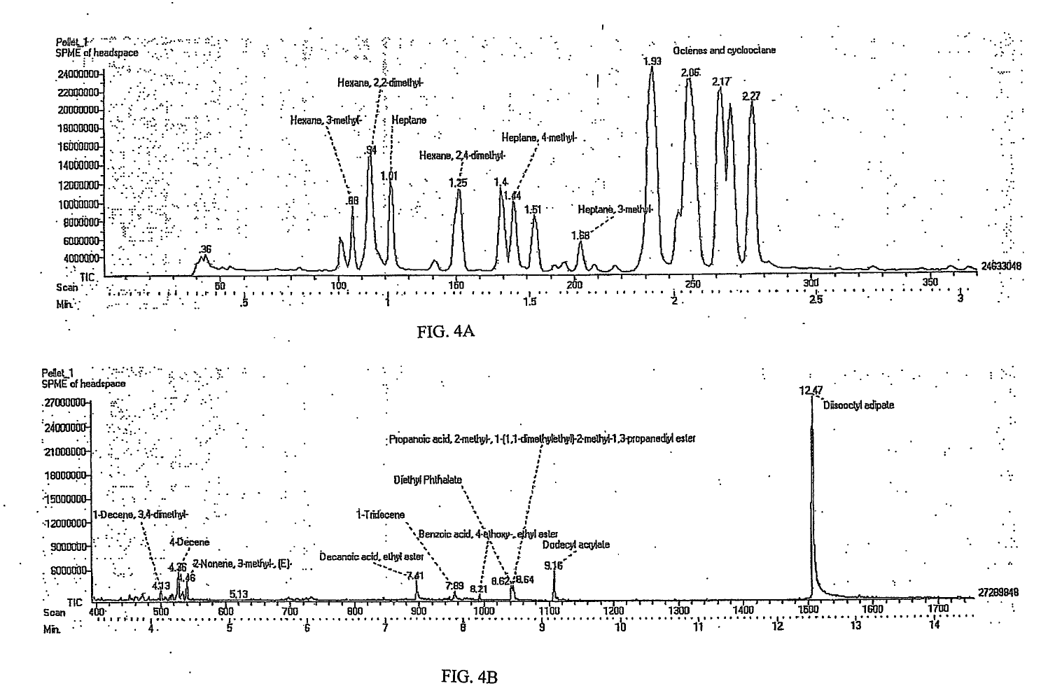

A sample of an octene copolymer linear low density polyethylene (LLDPE) was placed in a sealed glass container for longer than 24 hours. The container was then opened and the gas phase over the resin was sampled and analyzed using a gas chromatograph. FIGS. 4A and 4B show the results of the gas chromatograph indicating the species liberated from the polymer resin sample during storage in the sealed glass container.

Examples 7-10, infra, describe production of polymer samples containing ExxonMobil's EXCEED™ 1018 metallocene LLDPE (mLLDPE) granular film resin (“1018 resin”), 3001 hexene LLDPE film resin (“3001 resin”) and/or 1001 butene LLDPE film resin (“1001 resin”) (each resin from ExxonMobil Chemical Company, Houston, Tex.).

### Example 7

This Example describes production of a 3 layer blown polymer film from treated polymer resins.

1018 resin was treated at 150° F. (about 66° C.) for about 2 days in a Una-Dyn Dehumidifying Hopper Dryer, Model DHD-30 (Universal Dynamics Corp., Woodbridge Va.). 3001 resin was treated at 150° F. (about 66° C.) for about 3 days in a Una-Dyn Dehumidifying Hopper Dryer, Model DHD-30 (Universal Dynamics Corp., Woodbridge Va.). The resins were air cooled to room temperature following heat treatment. While the untreated resins had a noticeable odor, the treated resins exhibited little or no odor.

Using a 3 layer blown film production line such as that used in Examples 1-5 and operated under similar process conditions, a 25/50/25 (by weight) structure was produced using 1001 resin in the core as a filler and using either 1018 resin or 3001 resin in the skin layers. Untreated resins were also used to produce a control film. Because no antioxidant was initially present in the resin granules, a Vitamin E stabilizer package (Part No. AOC-0100E; Polyfil Corporation, Rockaway, N.J.) was added at 2 weight percent to prevent gels.

Using a 55 mil die gap, severe melt fracture (“shark-skin”) occurred on both treated and untreated resins, even when run at low rates. A 115 mil die gap was then used to produce films and melt fracture resulted on both samples, although it was not as severe as that produced using the 55 mil die gap. While running both treated and untreated 3001 resin, the line was slowed to 300 lb/hr (6 lb/hr/in) (about 136.4 kg/hr (about 6.9 kg/hr/cm) and an unacceptable level of melt fracture still resulted in the granular resin. Even at this reduced rate, no difference between films produced from treated and untreated resins was apparent.

Using commercial untreated pelletized 3001 resin containing an ExxonMobil stabilizer package but without processing aid, acceptable film was produced using the 115 mil die gap at 12 lb/hr/in (about 13.8 kg/hr/cm).

Using the 55 mil die gap, treated and untreated commercial pelletized 1001 resin were used in the skin layers to produce films (1001 resin was also used in the core). No apparent difference was seen in the performance of the treated pellets and melt fracture was eliminated on either sample (i.e., treated or untreated) by slowing the rate to approximately 220 lb/hr (about 100 kg/hr), again better than when using either treated or untreated granule resins.

### Example 8

This Example describes production of a single layer polymer sheet using a 3.5″ extruder with a vented screw feeding all layers in a combining adapter. A die gap of 0.040 inches (about 1 mm) was used on a 54 inch Cloeren die (Cloeren Incorporated, Orange, Tex.). The barrel zones were set to 100/340/350/430/425/425° F. (about 37.8/171.1/176.7/221.1/218.3/218.3° C.). All adapter and combining adaptor zones were set at 450° F. (about 232.2° C.) and all die zones were set to 440° F. (about 226.7° C.). While the operating conditions were being adjusted to eliminate vent flow, sometimes vent flow plugged the vent. Often, upon cleaning the vent, a loud “pop” was produced as built-up gasses escaped.

Three polymers were tested (1001 resin pellets, 1018 resin granules, and 3001 resin granules). Table 1 summarizes the results.

TABLE 1

| Polymer | Rate (lb/hr) | Rate (kg/hr) |
|---|---|---|
| 1001 Pellets | 93 | about 42.3 |
| 1018 Granules | 85 | about 38.6 |
| 3001 Granules | 111 | about 50.5 |

Melt fracture was less severe using the 1018 resin than using the 1001 resin at 30 rpm, and the sheet produced from the 1018 resin contained some clear bands.

The vent of the apparatus was then plugged and additional polymer sheet was produced. Table 2 summaries the results. The samples still had more scratch defects than when the screw was vented, and the polymer sheet was not as clear as the vented samples.

TABLE 2

| Polymer | Rate (lb/hr) | Rate (kg/hr) |
|---|---|---|
| 3001 Granules | 64 | about 29.1 |
| 1018 Granules | 73 | about 33.2 |

A vacuum was applied to the vent of the apparatus and additional samples were produced using the 3001 resin. Table 3 summaries the results. The data seem to indicate that a higher vacuum on the vent decreases the tendency for the melt curtain to exhibit melt fracture.

TABLE 3

| Vacuum (in. Hg) | Rate (lb/hr) | Rate (kg/hr) |
|---|---|---|
| 25 | 104 | about 47.3 |
| 22 | 90 | about 40.9 |
| 0 | 61 | about 27.7 |

### Example 9

This Example describes production of polymer sheet produced from devolatilized pellets of polymer resin. Samples of Equistar 601030 pellets and 3001 resin granules were compounded in a vented twin screw extruder by Carolina Compounders (Charlotte, N.C.) to produce 601330 Devolatilized Pellets and 3001 Devolatilized Pellets. Even though the resin in the Devolatilized Pellets had been compounded in a vented twin screw extruder, there was still a noticeable odor in the pellets (although not as severe as in the initial resin).

A sheet production apparatus operated as described in Example 8 (with a plugged vent) was used to produce the polymer sheets. Table 4 summarizes the results for these two resins as well as for 3001 resin granules produced under plugged vent conditions and with a 25 inches of mercury (in. Hg) vacuum applied to the unplugged vent. The devolatilized 3001 resin had almost no defects as the sheet exited from the die. There were a few defects 18 inches (about 45.7 cm) below the die, but they were very much reduced from non-devolatilized resin such as 1001 resin.

TABLE 4

| Polymer | Rate (lb/hr) | Rate (kg/hr) |
|---|---|---|
| 601330 Devolatilized Pellets (PV) | 100 | about 45.5 |
| 3001 Devolatilized Pellets (PV) | 153 | about 69.5 |
| 3001 Granules (Plugged Vent) | 64 | about 29.1 |
| 3001 Granules (Vacuum Applied) | 104 | about 47.3 |

In additional experiments, samples of the 601330 Devolatilized Pellets and 3001 Devolatilized Pellets were treated at 150° F. (about 66° C.) for about 2 days in a Una-Dyn Dehumidifying Hopper Dryer, Model DHD-30 (Universal Dynamics Corp., Woodbridge Va.). The treated, devolatilized pellets were then used to produce polymer sheet as described above using a vented apparatus with a plugged vent. In one test, 1 weight percent calcium stearate was blended with treated, devolatilized 3001 resin pellets prior to being fed to the extruder. Table 5 summarizes the results of these experiments.

TABLE 5

| Polymer | Rate (lb/hr) | Rate (kg/hr) |
|---|---|---|
| 601030 Treated & Devolatilized Pellets | 120 | about 54.5 |
| 3001 Treated & Devolatilized Pellets | 184 | about 83.6 |
| 3001 Treated & Devolatilized Pellets + | 227 | about 103.2 |
| Calcium Stearate | | |

Treatment in the hopper dryer, as described above, further reduced the tendency of the polymer sheet to melt fracture. The addition of calcium stearate further reduced this tendency.

### Example 10

This Example describes production of a 3 layer blown polymer film from treated polymer resins.

Using a 3 layer blown film production line such as that used in Examples 1-5 and under similar process conditions, a 25/50/25 (by weight) structure was produced using 1018 resin in the core as a filler and using either 601030 Treated & Devolatilized Pellets or 3001 Treated & Devolatilized Pellets in the skin layers.

During the production run, the surface haze fairly quickly disappeared from the 601030 Treated & Devolatilized Pellet film. About 20 minutes after starting with the 601030 resin at 500 lb/hr (about 227 kg/hr), clear (melt fracture free) streaks began to appear in the film. The film continued to improve for about an hour, and then it stabilized with 90% of the surface cleared, but with about 10% with minor melt fracture.

Then, films were made having the 3001 Treated & Devolatilized Pellets in the skin layers. One weight percent of a Vitamin E stabilizer as described in Example 7, supra, was added to these layers. The film quality stabilized within 45 minutes at 500 lb/hr with intermittent light melt fracture streaks. Samples were taken at 360, 390, 420, 450, 480, 510, 540 and 570 lb/hr (about 163.3, 177.3, 190.9, 204.5, 218.2, 231.8, 245.5, and 259.1 kg/hr). The 450 lb/hr (about 204.5 kg/hr) film sample appeared to be a commercially acceptable film. Even at 600 lb/hr (about 272.8 kg/hr), about 50% of the film was clear with the percentage that was affected by melt fracture increasing as the rate was increased.

While this invention has been particularly shown and described with references to preferred embodiments thereof, it will be understood by those skilled in the art that various changes in form and details may be made therein without departing from the scope of the invention encompassed by the appended claims.

1. A process for substantially eliminating the occurrence of surface aberrations during extrusion of a thermoplastic polymer, comprising:
(a) providing a thermoplastic polymer resin that has been treated by the application of heat in an atmosphere for a period of time sufficient to remove low molecular weight components, including organic compounds; whereby the thermoplastic polymer resin does not comprise processing aid; and
(b) extruding the heat treated and processing aid free thermoplastic polymer resin through a die wherein the extrusion conditions are such that the process would otherwise produce surface aberrations if the polymer resin were not treated to remove low molecular weight components in the absence of processing aid, thereby producing an extruded thermoplastic polymer product in which surface aberrations are substantially eliminated;
wherein the thermoplastic polymer resin and the resulting extruded thermoplastic polymer are substantially free of processing aid.

2. The process of claim 1 wherein the thermoplastic polymer resin comprises a linear low density polyethylene.

3. The process of claim 2 wherein the thermoplastic polymer resin comprises a solution phase linear low density polyethylene.

4. The process of claim 1 wherein the treated thermoplastic polymer resin is substantially in the form of resin pellets.

5. The process of claim 1 wherein step (b) is performed using a blown film extrusion process.

6. The process of claim 1 wherein step (b) is performed using a cast film extrusion process.

7. (canceled)

8. The process of claim 1 wherein the thermoplastic polymer resin has been treated by the application of heat in an atmosphere to remove substantially all low molecular weight components.

9. The process of claim 1 wherein the thermoplastic polymer resin has been treated by the application of heat in an atmosphere to remove low molecular weight compounds to a degree sufficient to substantially eliminate microcellular foaming.

10. The process of claim 1 wherein the thermoplastic polymer resin has been treated by heating at a temperature of at least about 130° F. (about 54.4° C.) for at least about 4 hours.

11. The process of claim 1 wherein the thermoplastic polymer resin has been treated by heating at a temperature of about 140° F. (about 60° C.) to about 160° F. (about 71.1° C.) for about 4 hours to about 60 hours.

12. The process of claim 1 wherein the thermoplastic polymer resin has been treated by heating to a temperature less than the melting point of the thermoplastic polymer resin.

13. The process of claim 1 wherein the provided thermoplastic polymer resin has been treated within a vented extrusion apparatus prior to extrusion through the die.

14. The process of claim 1 wherein the treated thermoplastic polymer resin is extruded using an extrusion apparatus such that during extrusion, low molecular weight compounds are removed from the resin prior to the resin exiting the die.

15. The process of claim 1 further comprising heating the thermoplastic polymer resin in an atmosphere sufficient to substantially eliminate the tendency to create surface aberrations.

16. The process of claim 15 wherein the atmosphere is an at least partial vacuum.

17. The process of claim 1 further comprising mixing the treated thermoplastic polymer resin prior to exit of the resin from the die.

18. The process of claim 17 wherein the resin is mixed using an inline static mixer.

19. The process of claim 17 wherein the thermoplastic polymer resin comprises low viscosity compounds and the concentration of the low viscosity compounds is substantially uniform throughout the thermoplastic polymer resin prior to exit of the resin from the die.

20. A thermoplastic polymer film produced by the process of claim 1.

21. The thermoplastic polymer film of claim 20 wherein the film comprises a linear low density polyethylene.

22. The thermoplastic polymer film of claim 20 wherein the film is a multi-layer thermoplastic polymer film.

23. A process for substantially eliminating surface aberrations during extrusion of a thermoplastic polymer, comprising extruding the thermoplastic polymer through a die wherein the thermoplastic polymer is substantially free of low molecular weight compounds, including organic compounds, and processing aid.

24. The process of claim 23 wherein the thermoplastic polymer resin comprises a linear low density polyethylene.

25. The process of claim 24 wherein the thermoplastic polymer resin comprises a solution phase linear low density polyethylene.

26. The process of claim 23 wherein the thermoplastic polymer resin is substantially in the form of resin pellets.

27. A thermoplastic polymer film produced by the process of claim 23.

28. The thermoplastic polymer film of claim 27 wherein the film comprises a polymer selected from the group consisting of polyethylene, linear low density polyethylene, and combinations thereof.

29. The thermoplastic polymer film of claim 27 wherein the film is a multi-layer film.

30. A process for producing a thermoplastic film, comprising:
(a) polymerizing ethylene to produce linear low density polyethylene;
(b) treating the linear low density polyethylene by the application of heat in an atmosphere for a period of time sufficient to remove low molecular weight components, including organic compounds, whereby the thermoplastic polymer resin does not comprise processing aid; and
(c) extruding the heat product of step (b) through a die to produce a thermoplastic film under extrusion conditions such that the process would otherwise produce surface aberrations if the polymer resin were not treated to remove low molecular weight components in the absence of processing aid;
wherein the thermoplastic film is substantially free of processing aid.

31. The process of claim 30 further comprising pelletizing the linear low density polyethylene prior to treating the linear low density polyethylene by the application of heat.

32. A low density polyethylene extrusion resin for blown film extrusion, comprising polyethylene that is substantially free of low molecular weight species, including organic compounds, and substantially free of processing aid.

33. The low density polyethylene resin of claim 32 wherein the resin is substantially free of a compound selected from the group consisting of ethylene, copolymerization monomer, polymers having carbon chains of less than about 12 carbon atoms in length, and water.

34. The low density polyethylene resin of claim 33 wherein the resin is substantially free of ethylene, copolymerization monomers, polymers having carbon chains of less than about 12 carbon atoms in length, and water.

35. The low density polyethylene resin of claim 32 wherein the resin comprises linear low density polyethylene.

36. A thermoplastic polymer resin wherein the resin has been treated by the application of heat in an atmosphere for a time sufficient to remove low molecular weight components, including organic compounds, to substantially eliminate the tendency to create surface aberrations during extrusion of the resin.

37. The thermoplastic polymer resin of claim 36 wherein the resin has been treated following a polymerization step whereby the polymer resin is formed.

38. The thermoplastic polymer resin of claim 37 wherein the resin has been treated following a pelletization step whereby the polymer resin is formed into pellets.

39. The thermoplastic polymer resin of claim 36 in the form of pellets.

40. The thermoplastic polymer resin of claim 36 wherein the thermoplastic polymer resin comprises linear low density polyethylene.

41. The thermoplastic polymer resin of claim 36 wherein the application of heat in an atmosphere has removed substantially all low molecular weight compounds.

42. The thermoplastic polymer resin of claim 36 wherein the resin is substantially free of a compound selected from the group consisting of ethylene, copolymerization monomer, polymers having carbon chains of less than about 12 carbon atoms in length, and water.

43. The thermoplastic polymer resin of claim 36 wherein the resin is substantially free of processing aid.

44. The thermoplastic polymer resin of claim 36 wherein the resin contains concentrations of low molecular weight species such that film extruded from said polymer will not have surface aberrations, as judged by the unaided eye, when extruded through a tubular film die having a 0.055 inch (about 1.4 mm) die gap at 400° F. (about 204° C.) and 12 lbs/hr/inch of die circumference (about 2.14 kg/hr/cm of die circumference).

45. An extruded thermoplastic polymer film comprising a thermoplastic polymer resin wherein the extruded thermoplastic polymer film is substantially free of low molecular weight species, including organic compounds, substantially free of surface aberrations, and substantially free of processing aid.

46. A process for treating a thermoplastic polymer resin susceptible to surface melt fracture comprising heating the thermoplastic polymer resin for a period of time sufficient to remove low molecular weight components, including organic compounds, to substantially eliminate surface melt fracture upon subsequent extrusion under conditions which would otherwise produce surface melt fracture.

47. The process of claim 46 wherein subsequent extrusion is through a tubular film die having a 0.055 inch (about 1.4 mm) die gap at 400° F. (about 204° C.) and a rate of 12 lbs/hr/inch of die circumference (about 2.14 kg/hr/cm of die circumference).

48. The process of claim 46 wherein the thermoplastic polymer resin is heated to remove low molecular weight components.

49. The process of claim 48 wherein the thermoplastic polymer resin is heated to a temperature less than the melting point of the thermoplastic polymer resin.
